(19) United States
(12) Patent Application Publication
(10) Pub. No.: US 2009/0239068 A1
(43) Pub. Date: Sep. 24, 2009

(54) HOUSING FOR MOBILE DEVICES

(75) Inventors: ZHENG SHI, Shenzhen City (CN); CHIH-CHIANG CHANG, Shindian (TW)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/402,745

(22) Filed: Mar. 12, 2009

(30) Foreign Application Priority Data
Mar. 19, 2008 (CN) 200810300634.3

(51) Int. Cl. B32B 27/20

(52) U.S. Cl. 428/339

(57) ABSTRACT

A housing includes a transparent substrate, a first decorative layer made of a partially transparent ink coating having a shiny powdery component mixed therein, and a second decorative layer made of a colored ink coating.

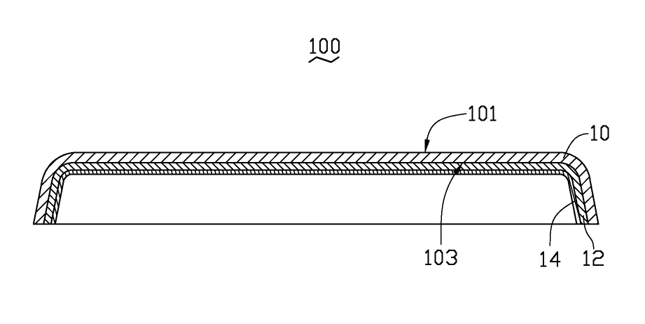

### BACKGROUND OF THE INVENTION

1. Field of the Invention

The present invention relates to housings for mobile device and, particularly, to a housing having metal luster for mobile devices such as portable telephones, portable computers, etc.

2. Discussion of the Related Art

Mobile devices, such as mobile telephones, personal digital assistants, or MP3 players, enable consumers to enjoy the convenience of high technology services, almost anytime and at virtually any location. These mobile devices often employ almost a variety of decorative housings to attract consumers. Most decorative housings are plastic molded articles manufactured by an injection molding process. Nowadays, housings with metal appearance are typically more attractive to consumers. To provide a metallic appearance, the plastic molded articles are typically coated with metal material by physical vacuum deposition processes. However, physical vacuum deposition processes are not suitable for depositing metal materials to form colorful patterns. Further, metal coatings formed on the plastic molded articles by physical vacuum deposition processes weakly adhere to plastic.

Therefore, there is room for improvement within the art.

### BRIEF DESCRIPTION OF THE DRAWINGS

Many aspects of the housing can be better understood with reference to the following drawing. The components in the drawing are not necessarily to scale, the emphasis instead being placed upon clearly illustrating the principles of the present housing. Moreover, in the drawing, like reference numerals designate corresponding parts throughout the following view.

The FIG is a cut-away view of an exemplary embodiment of the present housing.

### DETAILED DESCRIPTION OF THE EMBODIMENTS

Referring to the FIG, a housing 100 of the present embodiment includes a substrate 10, a first decorative layer 12 formed on the substrate 10, and a second decorative layer 14 formed on the first decorative layer 12, i.e., the first decorative layer 12 is sandwiched between the substrate 10 and the second decorative layer 14.

The substrate 10 includes an outer surface 101 and an inner surface 103. The substrate 10 may be made of a transparent plastic selected from a group including polycarbonate, poly methylmethacrylate, and polystyrene. Alternatively, the substrate 10 may be made of transparent glass material such as silicate glass, borate glass, and phosphate glass.

The first decorative layer 12 is a metallic lustered ink coating formed by a printing process. The metallic lustered ink coating is partially transparent, and includes an acrylic polymer component and a shiny powdery component selected from a group including metal powder and mica powder. Light may be reflected or dispersed by the shiny powdery component, which makes the first decorative layer 12 being partially transparent. The shiny powdery component is in an approximate wt. % of about 30 to 50 wt % of the first decorative layer 12. The thickness of the first decorative layer 12 may be about 3 to 5 microns. The shiny powdery component provides the first decorative layer 12 with shiny metallic luster.

The second decorative layer 14 may be a colored ink coating formed on the first decorative layer 12 by a printing process. The second decorative layer 14 provides a basic background color for the housing 100, which is enhanced by the shiny powdery component of the first decorative layer 12.

Accordingly, the housing 100 may show a colorful appearance with metallic luster which enables the housing 100 to be more attractive, when being viewed at a side facing the outer surface 101 of the substrate 10. The first decorative layer 12 and the second decorative layer 14 are formed at an inside of the housing 100, thereby protecting the first decorative layer 12 and the second decorative layer 14 from being scratched and abraded during using the housing 100.

The housing 100 may be a housing for mobile phones, laptop computers, cameras, or game player devices.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A housing, comprising:
a transparent substrate;
a first decorative layer made of a partially transparent ink coating having a shiny powdery component mixed therein; and
a second decorative layer made of a colored ink coating.

2. The housing as claimed in claim 1, wherein the first decorative layer includes an acrylic polymer component.

3. The housing as claimed in claim 1, wherein the shiny powdery component is selected from a group including metal powder and mica powder.

4. The housing as claimed in claim 3, wherein the shiny powdery component is in a wt. % of about 30 to 50 wt % of the first decorative layer.

5. The housing as claimed in claim 1, wherein the thickness of the first decorative layer is about 3 to 5 microns.

6. The housing as claimed in claim 1, wherein the substrate is made of a transparent plastic selected from a group consisting of polycarbonate, poly methylmethacrylate, and polystyrene.

7. The housing as claimed in claim 1, wherein the substrate is made of one of silicate glass, borate glass, and phosphate glass.

8. A housing, comprising:
a transparent substrate;
a metallic lustered ink coating formed on the transparent substrate; and
a colored ink coating covering the metallic lustered ink coating.

9. The housing as claimed in claim 8, wherein the metallic lustered ink coating includes an acrylic polymer component and a shiny powdery component.

10. The housing as claimed in claim 9, wherein the shiny powdery component is selected from a group consisting of metal powder and mica powder.

11. The housing as claimed in claim 10, wherein the shiny powdery component is in a wt. % of about 30 to 50 wt % of the first decorative layer.

12. The housing as claimed in claim 8, wherein the thickness of the first decorative layer is about 3 to 5 microns.

13. The housing as claimed in claim 8, wherein the substrate is made of a transparent plastic selected from a group consisting of polycarbonate, poly methylmethacrylate, and polystyrene.

14. The housing as claimed in claim 8, wherein the substrate is made of one of silicate glass, borate glass, and phosphate glass.
